(19) United States
(12) Patent Application Publication
(10) Pub. No.: US 2005/0206148 A1
(43) Pub. Date: Sep. 22, 2005

(54) Sensor arrangement for use with an air disc brake

(75) Inventors: Robert J. Nechvatal, Columbia Station, OH (US); Dennis R. Shamine, Lorain, OH (US)

Correspondence Address: CROWELL & MORING LLP;INTELLECTUAL PROPERTY GROUP, P.O. BOX 14300, WASHINGTON, DC, 20044-4300, US

(73) Assignee: Bendix Commercial Vehicle Systems LLC

(21) Appl. No.: 10/792,216

(22) Filed: Mar. 4, 2004

(51) Int. Cl. B60R 21/045

(52) U.S. Cl. 280/752

(57) ABSTRACT

An anti-lock braking system sensor arrangement for use with an air disc brake on an axle, particularly a commercial vehicle axle, wherein a wheel speed sensor is located outside a brake rotor envelope and a sensor exciter is located on an inward-extending portion of the axle hub or on the brake rotor, for example, adjacent to the junction of the rotor hat and its friction portion. The sensor exciter may be integrally formed with the axle hub or the rotor, or may be a separate exciter component affixed thereto. The sensor may be located adjacent to the exciter ring by locating the sensor in an axle flange or in a hole in the air disc brake caliper's mounting bracket. By locating the sensor and sensor exciter in this manner, sensor longevity is enhanced by improved cooling, and potential interference between the sensor and the air disc brake components is eliminated.

### BACKGROUND AND SUMMARY OF THE INVENTION

The present invention relates to disc brakes for vehicles, in particular, to pneumatically-operated disc brakes for commercial vehicles (also known as “air disc brakes”) and to arrangements of wheel speed sensor components employed with such brakes for use with, for example, anti-lock braking systems.

Pneumatically-operated disc brakes have been undergoing development and deployment on commercial vehicles since at least the 1970's, and are beginning to replace drum-style brakes due to advantages in areas such as cooling, fade resistance and serviceability. German patent publication DE 40 32 886 A1, and in particular FIG. 1 of this document, discloses an example of such an air disc brake. In this design, a pneumatic diaphragm chamber 12 is attached to a rear face of the disc brake caliper housing 3, and applies a brake actuation force through a linear actuator rod 10 to a brake actuator lever 9 within the caliper. The brake's actuator lever in turn transfers and multiplies the force applied by the actuator rod to one or more spindles 14, which force brake pads 20 against a brake disc or rotor 1. The terms “brake disc,” “rotor” and “brake rotor” are used interchangeably herein.

One factor inhibiting the rate of adaptation of air disc brake technology to commercial vehicle applications is potential interference between air disc brake components and existing anti-lock braking system (“ABS”) components such as sensors, sensor mounting brackets and sensor exciters. On commercial vehicle drive axles, these components typically have been located directly on or near the outer end of the axle, for example, a sensor exciter ring mounted on an inner end of a rotating hub, and a sensor head mounted on the axle stub on which the hub rotates. These locations can cause difficulties when air disc brakes are introduced into the limited space between the axle hub and the inner diameter of the wheel rim, because a small diameter brake disc hub (employed to provide enough room to mount the brake caliper within the wheel rim envelope) can strike conventionally located ABS sensors and/or exciters. FIG. 1 illustrates an example of such interference, wherein an anti-lock braking system wheel speed sensor 1 is mounted on an axle stub 2 of a commercial vehicle axle 3, in close proximity to an inner end 4 of rotating hub 5 (to which wheel rims 7 are bolted). At hub inner end 4, a sensor exciter in the form of a concentric toothed ring 8 of a type well known in the art (and thus not illustrated in detail) is disposed with its teeth facing wheel speed sensor 1 at a distance sufficiently close to induce electrical impulses in sensor 1 as the exciter's teeth rotate past the face of the sensor 1. As illustrated, if an air disc brake 9 utilizing a small inner diameter brake rotor 10 were mounted on the FIG. 1 axle, the inner surface 11 of brake rotor 10 would interfere with wheel speed sensor 1 in the region labeled “A” in FIG. 1.

Further, due to the deep offset of a typical commercial air disc brake rotor from its mounting surface on the axle hub to its friction surfaces, the brake rotors would effectively surround a conventionally located ABS sensor and exciter, leading to sensor and exciter serviceability problems (e.g., wheel removal required for virtually all ABS sensor or exciter servicing) and decreased sensor life due to exposure to elevated temperatures (due to reduced cooling air flow and increased radiated heat input from the surrounding brake rotor hub).

In order to overcome the foregoing problems, it is an object of the present invention to provide a sensor arrangement for use with an air disc brake wherein the ABS sensor is located axially inboard of the brake rotor, and the ABS sensor exciter is located outside the region of the inner diameter of the brake rotor hub.

It is a further object to provide an ABS sensor arrangement wherein the ABS sensor is mounted to one of an axle flange near to the brake rotor, on a dedicated ABS sensor mount affixed to the axle housing or, preferably, on an already-present bracket which bolts to the axle housing and receives the brake caliper (a so-called “air disc brake torque plate”).

It is a further object to provide an ABS sensor arrangement wherein the sensor exciter is mounted to a component which rotates with the axle hub and wheel, preferably an exciter ring affixed to the component or integrally formed thereon. In one embodiment, the exciter ring could be affixed to or integrally formed on an inner extension of the rotating axle hub which extends from an axle bearing portion of the hub into an open area inside the brake rotor's friction portion. In another embodiment, the exciter ring could be affixed to or integrally formed on the brake rotor, for example, at the junction of the rotor's friction portion and its hub portion (also known as the rotor “neck” or “hat” portion).

It should be noted that while the majority of the discussion herein is directed to ABS sensor components, the invention is not limited to anti-lock braking systems, but is equally applicable to wheel speed sensors employed with other monitoring or control systems, and to other types of sensors which are intended to obtain information from a vehicle axle hub or wheel, such as tire pressure or temperature sensors.

The present invention's location of the wheel speed sensor and exciter away from the end of the axle, and preferably mounted on existing air disc brake components, has a number of advantages. The direct exposure of the sensing components to the cooling air stream greatly enhances their cooling and thus their longevity. This sensor positioning also offers substantially improved inspection and servicing, as the sensor and its exciter are no longer shrouded by the hub portion of the brake rotor. Additional benefits include simpler and lower cost brake, axle hub and ABS system component designs, as well as the elimination of costs and potential errors associated with welding ABS sensor mounting blocks onto axle housings.

Other objects, advantages and novel features of the present invention will become apparent from the following detailed description of the invention when considered in conjunction with the accompanying drawings.

### BRIEF DESCRIPTION OF THE DRAWINGS

FIG. 1 is a cross-sectional illustration of potential interference between conventionally located ABS sensor components on a conventional commercial vehicle axle and an air disc brake rotor.

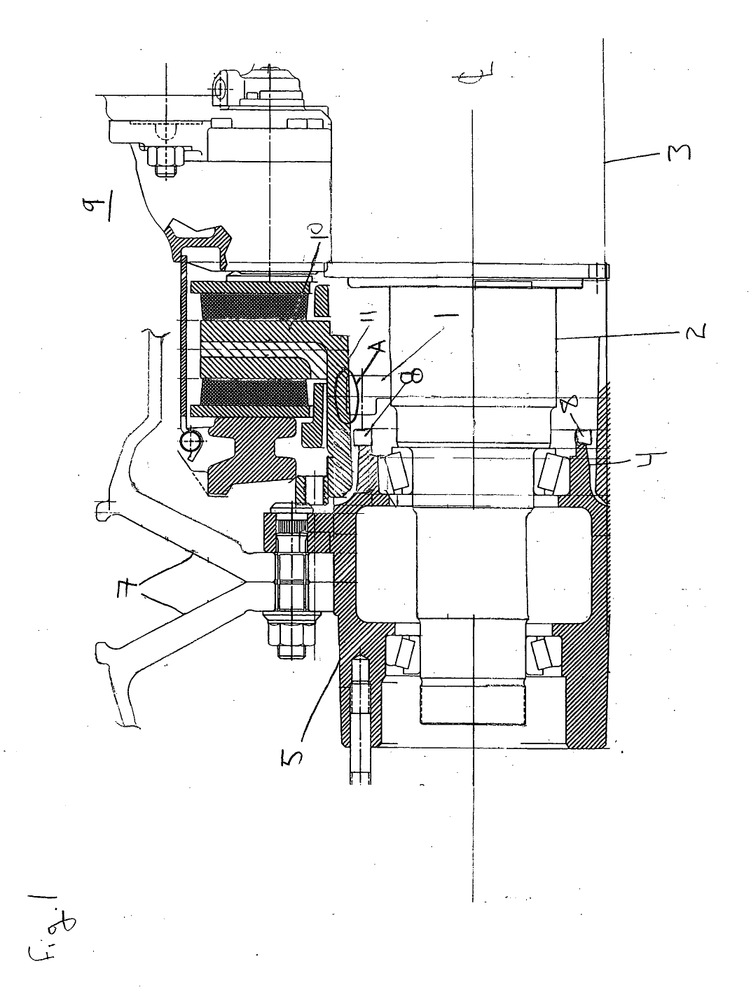

FIG. 2 is a cross-sectional schematic illustration of an ABS sensor and an ABS exciter arrangement in accordance with an embodiment of the present invention in which the sensor exciter is on the rotor.

FIG. 3 is a phantom perspective view of the ABS sensor and ABS exciter arrangement illustrated in FIG. 2.

FIG. 4 is a cross-sectional schematic illustration of an ABS sensor and an ABS exciter arrangement in accordance with a preferred embodiment of the present invention in which the sensor exciter is on an extension of the rotating axle hub.

### DETAILED DESCRIPTION OF THE DRAWINGS

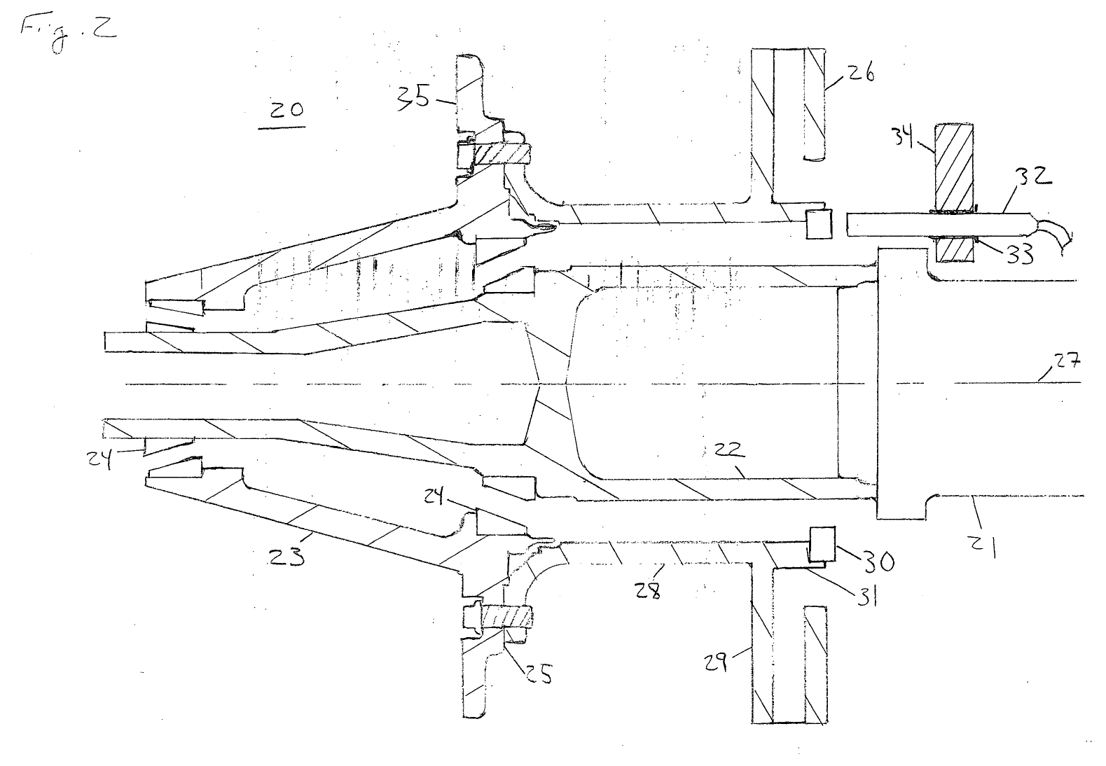

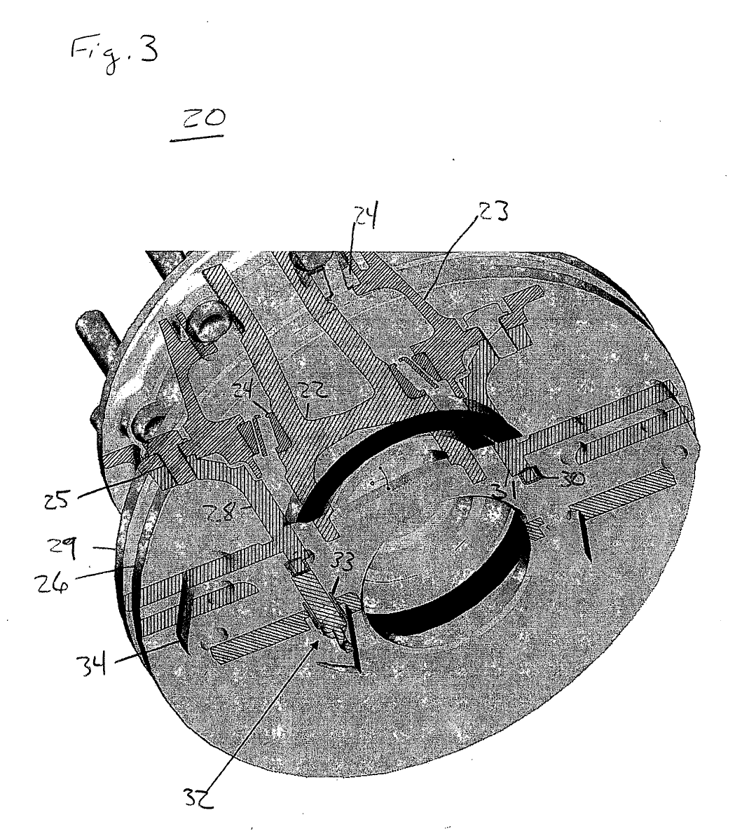

FIG. 2 is a cross-sectional view of an air disc brake-equipped commercial vehicle axle assembly 20. FIG. 3 is a phantom view of the assembly 20 arrangements provided to aid visualization of the assembly. The vehicle axle includes an axle housing 21 to which an axle stub 22 is affixed.

Axle stub 22 supports a rotating hub 23 on wheel bearings 24 in a conventional manner (bearing rollers and cages not illustrated). A vehicle wheel may be bolted to a flange portion 35 of hub 23 using, for example, lug nut studs (not illustrated). Prior to assembly on axle stub 22, an inboard face 25 of hub 23 is mated with a ventilated brake rotor 26 of the axle's air disc brake. The caliper portion of the air disc brake is not illustrated in FIG. 2 for clarity. In this embodiment, brake rotor 26 is bolted to hub 23 and rotates with the hub about the centerline 27 of the axle. Further, while brake rotor 26 is ventilated in this embodiment, other rotor configurations, such as a solid rotor may be employed.

The neck portion 28 of brake rotor 26 extends from hub inboard face 25 toward the longitudinal center of the vehicle axle. The length of neck portion 28 is sufficient to permit the air disc brake's caliper to straddle the friction portion 29 of brake rotor 26 without interference with other axle or wheel components. In this embodiment, neck portion 28 extends a sufficient distance toward the center of the axle to place a wheel speed sensor exciter ring 30 in the vicinity of axle housing 21. Exciter ring 30 may be affixed to brake rotor 26 in any of a number of well-known ways, such as by bolts or other fasteners. Alternatively, exciter teeth may be formed directly on the rotor, preferably in the vicinity of the junction of the hub portion and the friction portion of the rotor for ease of manufacture and alignment with the wheel speed sensor.

In the present embodiment, exciter ring 30 is held at an inner face of an extension 31 of the hub portion of the rotor. As shown in FIG. 2, rotor neck extension 31 holds exciter ring 30 away from the rotor's neck portion/friction portion junction, approximately even with the inner surface of rotor friction portion 29. However, the invention is not limited to this exciter location, as the sensor exciter may be located closer or farther away from axle housing 21 as desired to suit a particular application. Neck extension 31 facilitates placing the exciter ring closer to the axle flange, thereby minimizing the distance an ABS sensor needs to reach into the hub area to detect exciter movement.

The ABS wheel speed sensor 32 is held with its sensing head in close proximity to exciter ring 30, such that as brake rotor 38 rotates, the sensor detects the passage of teeth or apertures on exciter ring 30 (not illustrated). In the present embodiment, sensor 32 is located in a sleeve 33, which in turn is held by friction in a hole in the brake caliper mounting bracket 34 (or so-called “air disc brake torque plate”). Mounting bracket 34 may be affixed to vehicle axle housing 21 by any suitable attachment, for example, by bolting to flanges extending radially outward from housing 21 or by welding to the outer surface of housing 21, as long as the brake caliper can straddle the friction portion of the brake rotor and the sensing head of sensor 32 can be placed in close proximity to exciter ring 30.

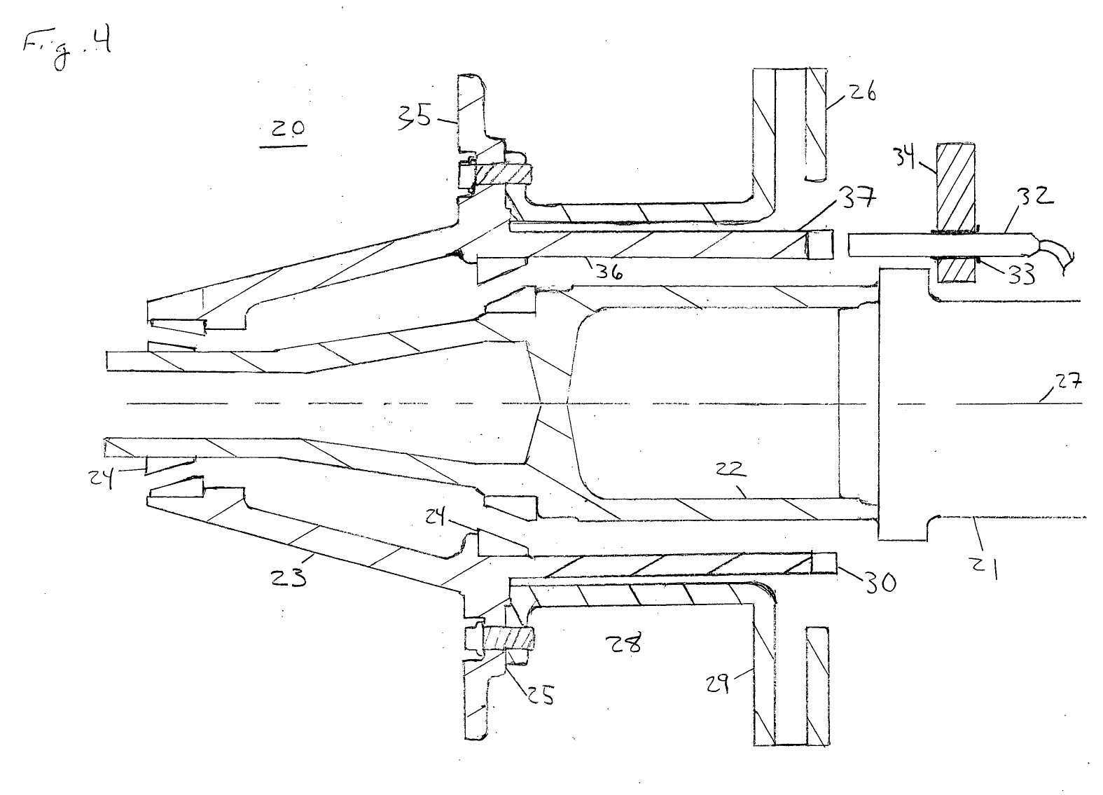

FIG. 4 illustrates a preferred embodiment of the present invention, wherein rather than locating the wheel speed sensor exciter ring on the brake rotor, the exciter ring is located on an inward extension of the rotating hub. The components shown in FIG. 2 in common with the embodiment of FIG. 4 are not described further. As illustrated in FIG. 4, in this embodiment rotating hub 23, to which brake rotor 26 is affixed, includes an axially-inward extending barrel portion 36. The diameter of the end portion 37 of extension 36 is sized to locate a sensor exciter ring 30 in proximity of the sensing portion of sensor 32. As with the previous embodiment, arranging the sensor exciter in this manner removes the sensing arrangements away from a shrouded region of the axle hub to improve cooling, component life and service access.

The foregoing disclosure has been set forth merely to illustrate the invention and is not intended to be limiting. For example, while the above illustrated embodiment includes a sensor exciter at an inner surface of the brake rotor near the axle housing, other locations on the brake rotor or the rotating hub may be employed, such as at an inner radius of the rotor's inboard friction surface, as long as the sensing head of the axle housing-mounted sensor can be located in close proximity to the sensor exciter. Because other such modifications of the disclosed embodiments incorporating the spirit and substance of the invention may occur to persons skilled in the art, the invention should be construed to include everything within the scope of the appended claims and equivalents thereof.

1. A sensor arrangement on a vehicle axle equipped with an air disc brake, comprising:
a wheel speed sensor; and
a sensor exciter, wherein
the sensor exciter is located on a rotor of the air disc brake,
the sensor is disposed adjacent to the exciter, such that the sensor is arranged to detect exciter motion.

2. The sensor arrangement of claim 1, wherein
the sensor exciter is located on the brake rotor adjacent to a junction of a friction portion of the brake rotor and a neck portion of the brake rotor.

3. The sensor arrangement of claim 2, wherein
the sensor exciter is formed integrally with the brake rotor.

4. The sensor arrangement of claim 2, wherein
the sensor exciter is formed as a ring and is attached to the rotor.

5. The sensor arrangement of claim 2, wherein
the sensor exciter is located on an extension of the neck portion of the brake rotor which extends axially from the junction of the friction portion and the neck portion toward a longitudinal center of the vehicle axle.

6. The sensor arrangement of claim 5, wherein
the sensor exciter is formed integrally with the neck portion extension.

7. The sensor arrangement of claim 5, wherein
the sensor exciter is formed as a ring and is attached to the neck portion extension.

8. The sensor arrangement of claim 1, wherein
the sensor is located closer to a longitudinal center of the vehicle axle than a neck portion of the brake rotor.

9. The sensor arrangement of claim 2, wherein
the sensor is located closer to a longitudinal center of the vehicle axle than a neck portion of the brake rotor.

10. The sensor arrangement of claim 5, wherein
the sensor is located closer to a longitudinal center of the vehicle axle than a hub portion of the brake rotor.

11. The sensor arrangement of claim 1, wherein
the sensor is located on an bracket which attaches a caliper of the air disc brake to the vehicle axle.

12. The sensor arrangement of claim 2, wherein
the sensor is located on an bracket which attaches a caliper of the air disc brake to the vehicle axle.

13. The sensor arrangement of claim 1, wherein
the wheel speed sensor is a component of an anti-lock braking system.

14. A vehicle axle assembly with an air disc brake and a sensor arrangement, comprising:
a vehicle axle;
an air disk brake located adjacent to a hub end of the vehicle axle;
a wheel speed sensor; and
a sensor exciter, wherein
the sensor exciter is located on a rotor of the air disc brake,
the sensor is disposed on the vehicle axle adjacent to the exciter, such that the sensor is arranged to detect exciter motion.

15. The vehicle axle assembly of claim 14, wherein
the sensor exciter is located on the brake rotor adjacent to a junction of a friction portion of the brake rotor and a neck portion of the brake rotor.

16. The vehicle axle assembly of claim 15, wherein
the sensor exciter is formed integrally with the brake rotor.

17. The anti-vehicle axle assembly of claim 15, wherein
the sensor exciter is formed as a ring and is attached to the rotor.

18. The vehicle axle assembly of claim 15, wherein
the sensor exciter is located on an extension of the neck portion of the brake rotor which extends axially from the junction of the friction portion and the neck portion toward a longitudinal center of the vehicle axle.

19. A sensor exciter for use with a vehicle axle equipped with an air disc brake, comprising:
a sensor exciter configured to generate an electrical signal in a wheel speed sensor affixed to the vehicle axle,
wherein the sensor exciter is adapted to be located on a rotor of the air disc brake in a position adjacent to the wheel speed sensor.

20. The sensor exciter of claim 19, wherein
the sensor exciter is located on the brake rotor adjacent to a junction of a friction portion of the brake rotor and a neck portion of the brake rotor.

21. The sensor exciter of claim 20, wherein
the sensor exciter is formed integrally with the brake rotor.

22. The sensor exciter of claim 20, wherein
the sensor exciter is formed as a ring and is attached to the rotor.

23. The sensor exciter of claim 20, wherein
the sensor exciter is located on an extension of the neck portion which extends axially from the junction of the friction portion and the neck portion toward a longitudinal center of the vehicle axle.

24. A brake rotor, comprising:
a brake disc including a friction portion and a neck portion,
wherein a sensor exciter configured to generate an electrical signal in a wheel speed sensor is located on the brake disc in a position adjacent to a junction of a friction portion of the brake rotor and a neck portion of the brake rotor.

25. The brake rotor of claim 24, wherein
the sensor exciter is formed integrally with the brake rotor.

26. The brake rotor of claim 25, wherein
the sensor exciter is formed as a ring and is attached to the rotor.

27. The brake rotor of claim 24, wherein
the sensor exciter is located on an extension of the neck portion which extends from the junction of the friction portion and the neck portion axially away from a hub end of brake disc.

28. A sensor mounting arrangement for use on a vehicle axle equipped with an air disc brake, comprising:
a wheel speed sensor; and
a torque plate for fixing a caliper of the air disc brake to the vehicle axle, wherein
the sensor is held by the torque plate between a brake caliper mounting portion of the torque plate and a vehicle axle attachment portion of the torque plate, and
a sensor exciter-detecting portion of the sensor is located at a position corresponding to a location of a sensor exciter arranged on a brake rotor of the air disc brake when the brake rotor is straddled by the brake caliper.

29. A sensor arrangement on a vehicle axle equipped with an air disc brake, comprising:
a wheel speed sensor;
a sensor exciter; and
an axle hub adapted to be rotatably supported on an outer end of the vehicle axle, wherein
the sensor is disposed on the vehicle axle at a location axially inboard of a rotor of the air disc brake,
the sensor exciter is located on an inwardly-extending portion of the rotating axle hub which extends towards a longitudinal center of the vehicle axle a distance sufficient to locate the sensor exciter within a range in which the sensor can detect exciter motion.

30. The sensor arrangement of claim 29, wherein
the sensor exciter is formed integrally with the inwardly-extending portion of the rotating axle hub.

31. The sensor arrangement of claim 29, wherein
the sensor exciter is formed as a ring and is attached to the inwardly-extending portion of the rotating axle hub.

32. The sensor arrangement of claim 29, wherein
the sensor is located on an bracket which attaches a caliper of the air disc brake to the vehicle axle.

33. The sensor arrangement of claim 29, wherein the wheel speed sensor is a component of an anti-lock braking system.

34. A vehicle axle assembly with an air disc brake and a sensor arrangement, comprising:
a vehicle axle;
an air disk brake located adjacent to a hub end of the vehicle axle;
a wheel speed sensor;
a sensor exciter; and
an axle hub adapted to be rotatably supported on an outer end of the vehicle axle, wherein
the sensor is disposed on the vehicle axle at a location axially inboard of a rotor of the air disc brake,
the sensor exciter is located on an inwardly-extending portion of the rotating axle hub which extends towards a longitudinal center of the vehicle axle a distance sufficient to locate the sensor exciter within a range in which the sensor can detect exciter motion.

35. The vehicle axle assembly of claim 34, wherein
the sensor exciter is formed integrally with the inwardly-extending portion of the rotating axle hub.

36. The anti-vehicle axle assembly of claim 34, wherein
the sensor exciter is formed as a ring and is attached to the inwardly-extending portion of the rotating axle hub.

37. A sensor exciter for use with a vehicle axle equipped with an air disc brake, comprising:
a sensor exciter configured to generate an electrical signal in a wheel speed sensor affixed to the vehicle axle,
wherein the sensor exciter is adapted to be located on an inwardly-extending portion of a rotating axle hub in a position adjacent to the wheel speed sensor.

38. The sensor exciter of claim 37, wherein
the sensor exciter is formed integrally with the inwardly-extending portion of the rotating axle hub.

39. The sensor exciter of claim 37, wherein
the sensor exciter is formed as a ring and is attached to the inwardly-extending portion of the rotating axle hub.
